(19) United States
(12) Patent Application Publication
(10) Pub. No.: US 2024/0359130 A1
(43) Pub. Date: Oct. 31, 2024

(54) HEAT RECOVERY IN A CO2 CAPTURE PLANT

(71) Applicant: Capsol Technologies ASA, Oslo (NO)

(72) Inventor: Stellan HAMRIN, Kungsör (SE)

(73) Assignee: Capsol Technologies ASA, Oslo (NO)

(21) Appl. No.: 18/571,899

(22) PCT Filed: Jun. 23, 2022
(86) PCT No.: PCT/NO2022/050149

§ 371 Date: Dec. 19, 2023

(30) Foreign Application Priority Data
Jun. 24, 2021 (NO) 20210813

(51) Int. Cl. B01D 53/14; B01D 53/18

(52) U.S. Cl. CPC B01D 53/1475; B01D 53/1425; B01D 53/18; B01D 2252/10; B01D 2257/504; B01D 2258/0291

(57) ABSTRACT

A method for removing CO₂ from a CO₂ rich gas, where the CO₂ containing gas is cooled and compressed to a pressure of 5 to 30 bar and introduced into an absorber (10) where the CO₂ rich gas is brought into countercurrent flow with an aqueous CO₂ absorbent to give a CO₂ lean gas flow and a CO₂ rich absorbent which are removed from the absorber (10) from the top and the bottom of the absorber, respectively, where the CO₂ lean gas is heated against the incoming CO₂ containing gas in a heat exchanger (2) and thereafter expanded over an expander (21), wherein compressed air is introduced into heat exchanger (2) together with the CO₂ lean gas, and a plant for performing the method, are described.

### FIELD OF INVENTION

The present invention relates to capture of CO₂ from a CO₂ containing gas flow, such as the exhaust gas from combustion of a carbonaceous material, or a waste gas from an industrial plant.

### BACKGROUND

The increase in atmospheric CO₂ concentration leading to an increase in the greenhouse effect to result in global climate changes is of great concern and have caused an environmental pressure towards stopping, or at least dramatically reducing, the use of fossil fuels and towards a change to renewable energy resources. However, a rapidly growing global energy demand and the fact that a change from fossil to renewable energy sources takes time and is expensive, carbonaceous fuels are expected to be important as energy sources for decades to come. Carbon Capture and Storage (CCS) has therefore become important in reducing the global CO₂ emission.

Many concepts and projects for CO₂ capture have been suggested, but few of them have developed from idea or drawing to actual projects, due to both high investment and running cost of such plants, and the lack of political support.

Most of the proposed projects for CO₂ capture are based on post combustion CO₂ capture, where CO₂ containing exhaust gas is introduced into an absorber, where the CO₂ containing gas is brought in intimate contact with a CO₂ absorbent to remove or at least substantially reduce the CO₂ content of the exhaust gas before it is released into the surroundings. The absorbent having absorbed CO₂ is then introduced into a stripper to regenerate the absorbent for re-use, and the captured CO₂ is removed for deposition/storage.

The most commonly suggested absorbents are inorganic absorbents, normally aqueous solution of potassium carbonate, and organic absorbents, normally aqueous solution of one or more organic amines or amino acids. Organic absorbents are prone to degradation during use, especially in presence of oxygen. Some of the degradation products of amines known from operation of such plants are known as toxic and carcinogenic compounds and may be released into the surroundings together with the CO₂ depleted exhaust gas. Operation of a capture plant using organic absorbents at a higher pressure than atmospheric pressure increases the problem of degradation as the partial pressure of oxygen is increase by compression. Potassium carbonate, at the other side, is relatively inexpensive, is chemically stable in the operating conditions of the capture plant and produces no toxic or carcinogenic degradation products.

The speed of reaction and system equilibria for capture of CO₂ in a capture plant is highly dependent on the partial pressure of CO₂ in the absorber, i.e., the part of the capture plant where the CO₂ containing gas is brought in intimate contact with the absorbent. Additionally, using high pressure reduces the gas volume, and makes it possible to reduce the size of the plant significantly, and thus reducing the construction cost.

WO 0048709, to Norsk Hydro, relates to a method for capturing CO₂ from an exhaust gas from a primary power plant, such as a gas turbine-based power plant. Expanded and cooled exhaust gas from the gas turbine power plant is re-compressed to a pressure of 5 to 30 bar, typically 7 to 20 bar, and cooled before the compressed gas is introduced into an absorber and brought in contact with an amine absorbent in an absorber of a CO₂ capture plant. The CO₂ depleted exhaust gas is reheated against the incoming exhaust gas before expansion of the gas over a turbine to give power for compression of the incoming exhaust gas. The drawback of this approach is that it needs a steam turbine plant and a separate HRSG to fully exploit the heat in the exhaust gas.

US20210813 A1 describes a method and a plant for CO₂ capture from an exhaust gas where the incoming exhaust gas is compressed in a compressor and introduced into a combustion chamber as an oxygen containing gas for combustion of natural gas. Compressed air is introduced into burners in the combustion chamber as the oxygen concentration of the exhaust gas is too low to start combustion. The exhaust gas leaving the combustion chamber, and being enriched in CO₂, is introduced into a CO₂ capture unit after being heat exchanged against CO₂ lean exhaust gas leaving the CO₂ capture unit. The CO₂ lean exhaust gas being reheated against the exhaust gas leaving the combustion chamber, is expanded over a turbine to regenerate some of the power used to compress the incoming exhaust gas. The solution of US20210813A1 is complex, complicated, and expensive. Additionally, the introduction of compressed air and natural gas into the combustion chamber increases the imbalance over the heat exchangers for heat exchanging the combustion gas leaving the combustion chamber against the CO₂ lean exhaust gas leaving the CO₂ capture unit.

The CO₂ capture process is an energy consuming process and substantial effort has been made to reduce the heat loss caused by the CO₂ capture process, as this is a bar for implementation CO₂ capture.

### SUMMARY OF THE INVENTION

According to a first aspect, the present invention relates to a method for removing CO₂ from a CO₂ rich gas, where the CO₂ containing gas is cooled and compressed to a pressure of 5 to 30 bar and introduced into an absorber where the CO₂ rich gas is brought into countercurrent flow with an aqueous CO₂ absorbent to give a CO₂ lean gas flow and a CO₂ rich absorbent which are removed from the absorber from the top and the bottom of the absorber, respectively, where the CO₂ lean gas is heated against the incoming CO₂ containing gas in a heat exchanger and thereafter expanded over an expander, wherein compressed air is introduced, together with the CO₂ lean gas, into the heat exchanger. Removal of CO₂ from the incoming gas flow reduces the total heat capacity of the gas. By introduction of compressed air together with the lean exhaust gas, the mixed air/lean gas gets an increased capacity to cool the incoming CO₂ containing gas and thereby to reduce heat loss in the system. This makes it possible to fully replace the commonly used HRSG/Steam Turbine with the Heat Exchanger/Expander that is already needed in the CO2 capture plant and only adding a smaller Air Compressor.

According to one embodiment, the incoming CO₂ containing gas has a temperature of 200 to 700 deg. C.

According to a second aspect the invention relates to a plant for removing CO₂ from a CO₂ rich gas, the plant comprising an exhaust gas line for introduction of the CO₂ rich gas into a heat exchanger for cooling of the incoming CO₂ rich gas, compressor(s) for compression of the CO₂ rich gas cooled in the compressor(s), a compressed exhaust gas line for introduction of the compressed exhaust gas into an absorber where the exhaust gas is brought in countercurrent flow against an aqueous CO₂ absorbent, a lean absorbent line for introduction of lean absorbent into the absorber, a lean exhaust gas line for withdrawal of CO₂ depleted, or lean, exhaust gas leaving and introduction thereof into the heat exchanger to be heated against the incoming exhaust gas, a heated gas line for leading the heated lean exhaust gas from the heat exchanger to an expander for expansion of the lean exhaust gas before being released into the surroundings via an expanded lean exhaust gas line, where a rich absorbent line is arranged for withdrawal of CO₂ rich absorbent from the absorber and introduction of the absorbent into a regeneration column for separation of absorbed CO₂ from the absorbent, where a CO₂ line is arranged for withdrawal of CO₂ and steam from the regeneration column, and the lean absorbent line is arranged for withdrawal of lean absorbent from the regeneration column and introduction thereof into the absorber, wherein a compressed air line is arranged for introduction of compressed air into the heat exchanger together with the lean exhaust gas introduced through the lean exhaust gas line.

According to one embodiment of the second aspect, the one or more air compressors for compression of air to the compressed air line are arranged on a common shaft together with the expander and the motor or combined motor and generator.

### SHORT DESCRIPTION OF THE FIGURES

FIG. 1 is a principle sketch of an embodiment of the present invention.

### DETAILED DESCRIPTION OF THE INVENTION

A CO₂ rich gas as used in the present description and claims, is a gas having a CO₂ concentration being substantially higher than the CO₂ concentration in air, i.e. a concentration substantially higher than 0.04%, such as higher than 1%, 2%, 5%, or even higher than 10%. The CO₂ rich gas, as used herein, is usually an exhaust gas from combustion of carbonaceous fuels, and more specifically fossil fuels. However, the present method may also be used for capturing CO₂ from exhaust gas from combustion of non-fossil fuels, combination of fossil and non-fossil fuels, such as waste, or for CO₂ capture from any industrial waste gas comprising CO₂, and where the remaining waste gas may be released into the surroundings after CO₂ capture.

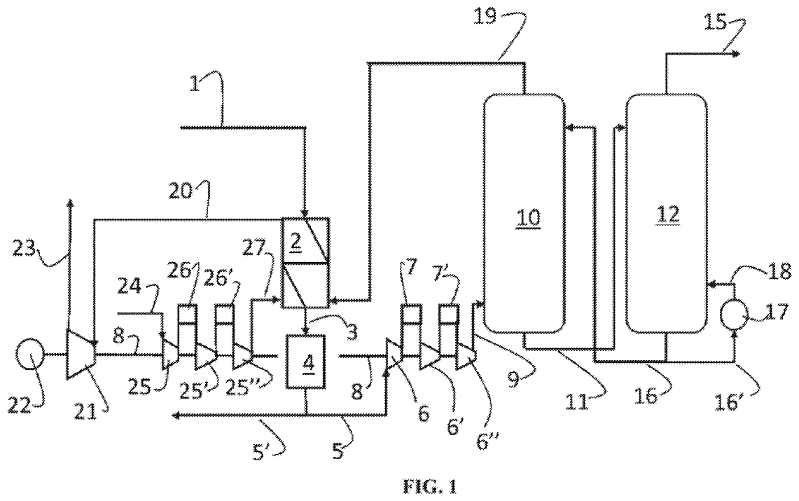

A typical CO₂ capture plant is shown in FIG. 1, where incoming CO₂ rich gas, such as exhaust gas from combustion of carbonaceous material, such as a gas turbine, a coal fired plant power plant, an incarnation plant for waste, or an industrial exhaust gas, is introduced through an exhaust gas line 1, at about atmospheric pressure and typically at a temperature from 200 deg. C. to 700 deg. C. The incoming gas in exhaust gas line 1 is introduced into a heat exchanger 2, where the gas is cooled against CO₂ depleted gas as will be described further below, to a temperature from about 90 deg. C. to 150 deg. C. The partly cooled exhaust gas excites the heat exchanger 2 through a gas line 3, is introduced into an exhaust gas cooler 4, where the gas is cooled to about 20 deg. C. to 70 deg. C. The cooled exhaust gas is withdrawn through a cooled gas line 5 and led to serially connected compressors, here illustrated as three compressors, 6, 6′, 6″, which are arranged on a common shaft 8. Intercoolers 7, 7′ are arranged between the compressors to cool the compressed gas before the next compressor step.

If the source for the incoming CO₂ rich gas is a gas turbine, a fraction of the gas with drawn from the exhaust gas cooler 4 may be withdrawn from the gas line 5 in an optional withdrawal line 5′ and mixed with the air to be introduced into the gas turbine for combustion to reduce the oxygen concentration and increase the CO₂ concentration in the exhaust gas.

The compressed exhaust gas leaving the serially connected compressors is led in a compressed exhaust gas line 9 and is introduced into an absorber 10 where the exhaust gas is brought in countercurrent flow against an aqueous potassium carbonate absorbent. The absorbent having absorbed CO₂, “rich absorbent”, is collected at the bottom of the absorber column 10 and is withdrawn through a rich absorbent line 11.

The rich absorbent in line 11 is introduced into the upper part of a regeneration column 12, where the rich absorbent is brought into countercurrent flow to steam. CO₂ is released from the absorbent by stripping with hot steam, and steam and CO₂ is withdrawn through a CO₂ line 15 for further treatment. The regenerated, or lean, absorbent is collected at the bottom of the regeneration column 12 in a lean absorbent line 16 and led to the upper part of the absorber 10 where the regenerated absorbent is introduced to absorb CO₂. A part stream of the regenerated absorbent is withdrawn from the lean absorbent line 16 in a reboiler line 16′ and introduced into a reboiler 17 where the absorbent is boiled to produce steam. The steam produced in reboiler 17 is introduced into regeneration column 12 via a steam line 18.

The skilled person will understand that the CO₂ capture part of the described plant, i.e. the absorber, the regeneration column, the connections between them and connected equipment is described without entering into specific details on optimalization to increase the energy efficiency of the CO₂ capture/reduce the heat loss connected to CO₂ absorption and desorption. The skilled person can identify several different solutions/measures and combination of measures possible to reduce heat loss.

CO₂ lean exhaust gas, i.e. exhaust gas from which CO₂ has been removed by absorption in absorber 10, is withdrawn from the absorber through a lean exhaust line 19 and introduced into the heat exchanger 2 where the lean exhaust gas is heated against the incoming CO₂ rich exhaust gas introduced through line 1. Additionally, compressed air at substantially the same pressure as the lean exhaust gas is introduced into the heat exchanger 2 from a compressed air line 27, to increase the total mass flow of gas to be heated therein. Air is taken in through an air intake 24, and compressed in a train of air compressors 25, 25′, 25″. Preferably intercoolers 26, 26′ are arranged between the air compressors 25,25′, 25″.

A heated gas flow, comprising lean exhaust gas and compressed air, is withdrawn from the heat exchanger 2 in a heated gas line 20 and is expanded to atmospheric pressure over an expander 21 before being released into the surroundings via an expanded lean exhaust gas line 23.

The compressors 6, 6′, 6″, 25, 25′, 25″, and the expander 21 are all preferably connected to a common shaft 8. Depending on the temperature at gas line 1 and heat loss in the present plant, the expander 21 might not be able to give the power needed to operate the compressors. A motor or combined motor and generator 22, is therefore connected to the shaft 8 to give the additional power needed, or to generate electrical power if the expander gives more power than needed by the compressors connected to the shaft.

According to the present invention, air is compressed and introduced into the heat exchanger 2 together with the lean exhaust to substitute the heat capacity flow lost in the lean exhaust gas due to the removal of CO₂ from the exhaust gas in the absorber 10. By introducing a flow of air substantially equal in heat capacity of the captured CO₂ a more efficient transfer of heat from the incoming exhaust gas in line 1 is transferred to the total volume of the compressed air and lean exhaust gas introduced into the heat exchanger 2 from lines 27, 19, respectfully. The power generated by the expander 21 depends on the temperature in line 1. The more of the heat energy that is transferred from the incoming exhaust gas in line 1 to the compressed lean exhaust gas and compressed air in heat exchanger 2, the more power is generated in expander 21 to reduce the necessary power input from the motor or combined motor and generator 22, and at higher temperatures more power is generated in the expander 21 than needed to operate the compressors 25, 25′, 25″ and 6, 6′, 5″ to make it possible to generate electrical power in the motor or combined motor and generator 22.

This way each extra kg/s of air filled in at line 24 can at 600 deg. C. at line 1 add more than 150 kW of net mechanical work from the expander 21 and the compressors 25, 25′ and 25″.

1. A method for removing CO₂ from a CO₂ rich gas, where the CO₂ containing gas is cooled and compressed to a pressure of 5 to 30 bar and introduced into an absorber where the CO₂ rich gas is brought into countercurrent flow with an aqueous CO₂ absorbent to give a CO₂ lean gas flow and a CO₂ rich absorbent which are removed from the absorber from the top and the bottom of the absorber, respectively, where the CO₂ lean gas is heated against the incoming CO₂ containing gas in a heat exchanger and thereafter expanded over an expander, wherein compressed air is introduced into heat exchanger together with the CO₂ lean gas.

2. The method of claim 1, wherein the incoming CO₂ containing gas has a temperature of 200 to 700 deg. C.

3. A plant for removing CO₂ from a CO₂ rich gas, the plant comprising an exhaust gas line for introduction of the CO₂ rich gas into a heat exchanger for cooling of the incoming CO₂ rich gas, compressor(s) for compression of the CO₂ rich gas cooled in the intercooler, a compressed exhaust gas line for introduction of the compressed exhaust gas into an absorber where the exhaust gas is brought in countercurrent flow against an aqueous CO₂ absorbent, a lean absorbent line for introduction of lean absorbent into the absorber, a lean exhaust gas line for withdrawal of CO₂ depleted, or lean, exhaust gas leaving and introduction thereof into the heat exchanger to be heated against the incoming exhaust gas, a heated gas line for leading the heated lean exhaust gas from the heat exchanger to an expander for expansion of the lean exhaust gas before being released into the surroundings via an expanded lean exhaust gas line, where a rich absorbent line is arranged for withdrawal of CO₂ rich absorbent from the absorber and introduction of the absorbent into a regeneration column for separation of absorbed CO₂ from the absorbent, where a CO₂ line is arranged for withdrawal of CO₂ and steam from the regeneration column, and the lean absorbent line is arranged for withdrawal of lean absorbent from the regeneration column and introduction thereof into the absorber, wherein a compressed air line is arranged for introduction of compressed air into the heat exchanger together with the lean exhaust gas introduced through the lean exhaust gas line.

4. The plant according to claim 3, wherein one or more air compressors are arranged on a common shaft together with the expander and a motor or generator.
